(19) United States
(12) Patent Application Publication
(10) Pub. No.: US 2003/0107950 A1
(43) Pub. Date: Jun. 12, 2003

(54) Apparatus for mixing

(76) Inventors: Ian Clarence Shepherd, Victoria (AU); Clive Filleul Grainger, Victoria (AU)

Correspondence Address: SUGHRUE MION, PLLC, 2100 PENNSYLVANIA AVENUE, N.W., WASHINGTON, DC, 20037, US

(21) Appl. No.: 10/169,950

(22) PCT Filed: Jan. 11, 2001
(86) PCT No.: PCT/AU01/00018

(30) Foreign Application Priority Data
Jan. 11, 2000 (AU) PQ 5039

(51) Int. Cl. B01F 7/26

(52) U.S. Cl. 366/317; 366/325.1; 366/329.1; 366/330.1

(57) ABSTRACT

A rotor to establish a swirling flow in liquid(s) contained in a vessel. In one form the rotor includes two parallel spaced apart discs. An array of vanes is interposed between the discs. One of the discs is annular to define an inlet to the array of vanes. The inlet controls the size of an inner core region of the swirling flow. In another form the rotor has at least two hollow spokes directed radially outwardly from the central hub. The spokes each have a passage with an inlet directed toward the hub and a radially directed outlet. Rotation of the rotor produces a flow through the spokes that contributes to the rotational radially outward flow that establishes the swirling flow. In another form of the invention the rotor includes at least two blades directed radially outwardly from a central hub. The blades include at least one surface inclined to the direction of rotation of the rotor. The blades induce a flow in the axial direction as the rotationally outward flow is created to establish the swirling flow.

### FIELD OF THE INVENTION

This invention relates to apparatus for mixing liquids or liquid with particles to form slurries and the like. The apparatus of the present invention is suitable for mixing one liquid with another or mixing liquid with particles to form both homogeneous suspensions as well as mixtures in which not all of the particles are fully suspended. The invention is intended for applications where entrainment of gas from the liquid surface during mixing is undesirable and to be avoided.

### BACKGROUND ART

Apparatus for mixing of this type has a number of applications in a wide variety of industrial processes. One such application is agitated precipitators used in the process of precipitating crystals from a supersaturated liquor. Precipitators of this type are used in a number of industrial processes. The invention will hereinafter be specifically described with reference to this application but it will be readily appreciated that the scope of the invention is not limited to this particular application.

One well known agitating precipitator is the Gibbsite precipitator used in the Bayer process to produce alumina hydrate from bauxite. A common form of existing Gibbsite precipitator comprises a large vessel with a centrally disposed draft tube. An impeller is rotationally driven in the draft tube to provide a vertical circulation in the precipitator. In some cases baffles or vanes are provided around the sides of the vessel or in the draft tube to prevent swirling or rotational flow in the slurry which otherwise impairs the desired vertical circulation. One of the objects of the precipitation process is to produce large crystal size in the precipitate. Because the existing Gibbsite precipitators involve a fairly energetic process as the slurry is drawn through the draft tube and comes into contact with the rotor blades, there is a tendency to break crystal structures. This limits the size of the crystals that can be produced using these precipitators. Another difficulty with Gibbsite precipitators is the scaling that occurs on the precipitator walls due to the low flow velocities. In particular, a substantial deposition of material occurs in the bottom of the vessels and in the areas of stagnant flow. As a consequence, the vessels need to be periodically cleaned. Not only is cleaning an additional expense, but also provides a significant disruption to production and can reduce the life of the vessel.

Similar difficulties exist in other apparatus for mixing liquids and liquids with particles in various industrial situations.

The present applicants' International Patent Application WO 99/08781 (“the earlier application”) describes a method and apparatus for mixing liquids or liquids with particles without aeration of the liquid. In the earlier application mechanical rotating means such as a paddle or impeller disposed adjacent an upper end of a vessel to establish a swirling flow through the vessel. The disclosure of the earlier application is incorporated herein by cross reference.

### DISCLOSURE OF THE INVENTION

The present invention is directed toward improvements in the method and apparatus described in the earlier application. In particular the present invention seeks to provide a number of improved mechanical rotating means, generally referred to as rotors, for application in vessels of different types.

The rotors of this invention are all for use in an apparatus for mixing liquids or liquids with particles without deliberate entrainment of gas from the liquid surface. The apparatus includes a vessel to contain the liquid(s) having an upper end, a lower end and a containing wall extending between the upper and lower ends. The mechanical rotating means, or rotor, is disposed adjacent the upper end of the vessel to introduce a rotational flow in the liquid directed radially outward from a central region of the vessel towards the containing wall to establish a swirling flow through the vessel. The swirling flow is characterised by an outer annular region of moderate rotational flow adjacent the containing wall moving from the upper end of the vessel toward the lower end, an inward flow adjacent the lower end of the vessel, and an inner core region of rapid rotational flow about the central region of the vessel moving from the lower end toward the upper end and extending from substantially adjacent the lower end of the vessel to the rotor. As used in this specification a “swirling flow” is intended to refer to a flow characterised by these features.

In a first aspect this invention provides a rotor to establish a swirling flow in liquid(s) contained in a vessel having an upper end, a lower end and a containing wall extending between the upper and lower ends by being submerged in the liquid adjacent the upper end, said rotor including two substantially parallel spaced apart generally planar discs extending perpendicular to an axis of rotation, an array of vanes interposed between the discs, one of said discs being annular to define an inlet to said array of vanes, said inlet controlling the size of an inner core region of said swirling flow.

The vanes are preferably evenly spaced around a circular region centred on the axis of rotation. Preferably, the vanes are substantially perpendicular to the planes of the discs. In one form of the invention one of the discs, referred to as a top plate, has no opening. The annular disc is known as the lower plate. The flow of liquid from the vessel enters the rotor by rising in a column defining the innercore region. The flow through the passages defined between the vanes and discs has radial and swirl components of velocity but little axial velocity.

Depending upon the application the vanes can be forward swept, radial or back swept to achieve the desired exit swirl velocity. Large size rotors preferably have radial or back swept vanes. Smaller rotors preferably have forward swept vanes. The overall diameter of the rotor is an important parameter influencing rotor characteristics. In general, large diameter rotors generate high torque and low rotational speed. The ratio of rotor diameter to vessel diameter is usually in the range of from 0.26 to 0.65.

The depth of the rotor is selected to maintain a minimum velocity through the passages defined in the rotor and to match the flow-pressure characteristic of the fluid circulating in the body of the vessel. Swirl velocity at the outlets of the rotor passages is equivalent to additional pressure and therefore the vane sweep at the outer edge, the overall diameter, and the depth of the rotor all influence the total pressure characteristic of the rotor. The ratio of rotor depth to overall rotor diameter is usually in the range of 0.03 to 0.3.

Large narrow rotors, such as those with ratio of rotor depth to rotor diameter at the low end of this range provide high pressure at relatively low flow circulation rate. Conversely, small deep rotors with a ratio of rotor depth to rotor diameter toward the upper end of the above range provide high circulation. For the given vessel a limit of rotor depth occurs when the rotor stalls because it cannot provide the pressure and flow requirement.

The diameter of the inlet opening at the bottom plate determines the diameter and intensity of the inner core region of the swirling flow which keeps solid particles, for example, in suspension. Small openings gives smaller more intense columns to provide a stronger uplift over a smaller area of the bottom of the vessel. In conical bottom vessels full suspension solids is achieved at a lower power with smaller openings in the bottom plate. Conversely, in flatter bottom vessels the narrow intense up-flowing column leaves settled particles on the outer regions of the bottom. Consequently, rotors with larger openings in the bottom plate tend to be more effective for use with flatter bottom vessels.

In another aspect this invention provides a rotor to establish a swirling flow in liquid(s) contained in a vessel having an upper end, a lower end and a containing wall extending between the upper and lower ends by being submerged in the liquid adjacent the upper end, said rotor including at least two hollow spokes directed substantially radially outwardly from a central hub, said spokes each having a passage with an inlet directed toward said hub and a radially directed outlet such that rotation of the rotor produces a flow through the spokes that contributes to the rotational radially outward flow establishing said swirling flow.

The spokes can be attached to the hub radially or disposed at an angle to the radial direction. Any suitable number of spokes can be used and preferably the spokes are evenly spaced about the central hub.

The outer surface of the spokes generates a force on the fluid which in combination with the flow through the spokes generates the required rotational radially outward flow. Preferably about 30% of the flow is established by fluid passing through the passage.

The outer surfaces of the spokes can be selected to appropriately direct the radially outward flow. More particularly, a lift or drag force can be applied by the surface of the rotors depending upon the selected shape and inclination of the shape relative to the fluid flow. In one preferred configuration airfoil sections can be used. The airfoil sections are preferably set at a pitch angles that determine the external surfaces of the spokes produce thrust in the axial direction as well as radially outward flow. In this configuration the flow from the passages in the spokes provides a flow similar to the flow from the passages through the disc rotors described above.

The spokes can be arranged either radially or tangentially to a small circle about the hub so that smooth the entry of the inlet flow to the passage can be achieved.

It will be apparent that the spoked configuration allows practical rotors of large diameters to be fabricated. As in the case of the disc rotor described above the overall diameter is the major influence on rotor characteristic. Large diameters generate high torque at low rotational speed. Spoked rotors usually have a ratio of tip diameter to vessel diameter of between 0.5 and 0.9.

In some configurations additional blades can be added to the spokes to increase the surface area and produce a high torque rotor.

It is also possible to combine the disc rotor and spoke rotors described above to perform a composite rotor including features of both.

In a further aspect this invention provides a rotor to establish a swirling flow in liquid(s) contained in a vessel having an upper end, a lower end and a containing wall extending between the upper and lower ends by being submerged in the liquid adjacent the upper end, said rotor including at least two blades directed radially outwardly from a central hub, said blades including at least one surface inclined to the direction of rotation of the rotor to induce a flow in the axial direction as the rotational radially outward flow towards the containing wall is created to establish said swirling flow.

The blades can extend from substantially adjacent the hub or may be mounted on outwardly extending arms. The inner diameter defined by the blades controls the size of the inner core region of the swirling flow.

The blades can in some applications have an airfoil section. In addition the blades can be hollow with an inlet directed toward the hub and a radially directed outlet so as to function in the same manner as the spoked rotor described above.

The invention also includes within its scope mixing apparatus formed by combinations of rotors of the kind described above with mixing vessels of various diameters and bottom shapes. In particular, as described above certain design have been found to be more suitable with vessels having a conically shaped bottom while as other rotors are best suited to flat bottomed vessels.

The invention will now be described, by way of example only, with reference to the accompanying drawings.

### BRIEF DESCRIPTION OF THE DRAWINGS

FIG. 1 shows a large disc rotor according to the present invention on the left hand side designated Rotor 1. A small disc rotor according to the present invention designated Rotor 2 is shown on the right hand side;

FIG. 2 shows a small disc rotor with increased depth according to this invention designated Rotor 3 on the left hand side. The rotor Rotor 2 of FIG. 1 is also shown on the right hand side;

FIG. 3 shows a medium size disc rotor according to the present invention designated Rotor 4b. The rotor Rotor 2 of FIG. 1 is also shown on the right hand side;

FIG. 4 shows an eight spoked rotor with airfoil spokes according to the present invention designated Rotor 5. The Rotor 2 of FIG. 1 is also shown on the right hand side;

FIG. 5 shows a large non-hollow spoked rotor according to the present invention designated Rotor 6-. The Rotor 2 of FIG. 1 is also shown on the right hand side;

FIG. 6 shows a large diameter two-spoked rotor according to the present invention designated Rotor 7. The Rotor 2 of FIG. 1 is also shown on the right hand side;

FIG. 7 shows a four spoke rotor according to the present invention designated Rotor 8a. The Rotor 2 of FIG. 1 is also shown on the right hand side;

FIG. 8 shows a large diameter four-spoke rotor according to the present invention designated Rotor 9. The Rotor 2 of FIG. 1 is also shown on the right hand side;

FIG. 9 shows a spoked rotor with attached plates according to the present invention designated Rotor 10. The Rotor 2 of FIG. 1 is also shown on the right hand side;

FIG. 10 shows a combination of disc and spoke rotors designated Rotor 11. The Rotor 2 of FIG. 1 is also shown on the right hand side;

FIG. 11 is a plot of rotor power consumption and rotor torque for solids “just suspended” in conical, bottomed and flat bottomed vessels for the various rotor types.

### BEST MODES FOR CARRYING OUT THE INVENTION

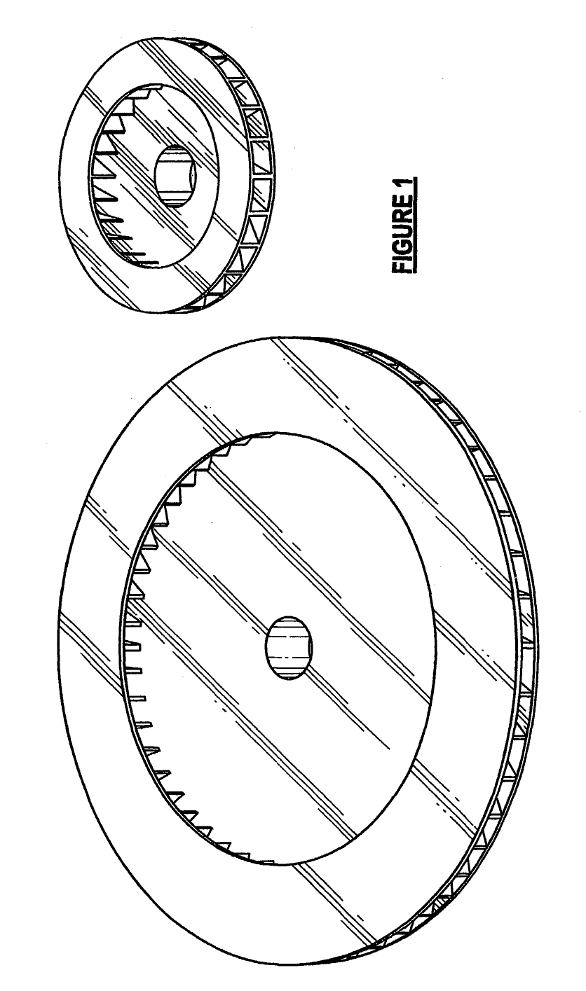

The rotors shown in FIGS. 1, 2 and 3 are all formed by parallel spaced apart discs 1, 2 perpendicular to a connecting boss 3. The boss 3 provides for connection with a drive shaft (not shown) in a conventional manner. An array of equally spaced vanes 4 is interposed between the discs 1, 2. The vanes are either straight or arcuate as described below. Disc 1 is a top plate and has no opening. Disc 2, is annular and provides an inlet to the array of vanes 4.

FIG. 1 shows a large disc Rotor 1 according to the present invention. The vanes 4 are straight and are radially directed. Rotors of this type can have vanes 4 that are either radially directed or swept way back from the direction of rotation. The ratio of rotor diameter to vessel diameter for Rotor 1 is about 0.65. The ratio of rotor depth to rotor tip diameter is 0.032.

Rotor 2 illustrated in FIG. 1 is a smaller diameter rotor with vanes 4 swept forward in the direction of rotation. The bades are straight and form an angle of about 23° to the radial direction. The ratio of rotor diameter to vessel diameter for rotor Rotor 2 is typically about 0.28. The ratio of rotor depth to rotor tip diameter is about 0.11.

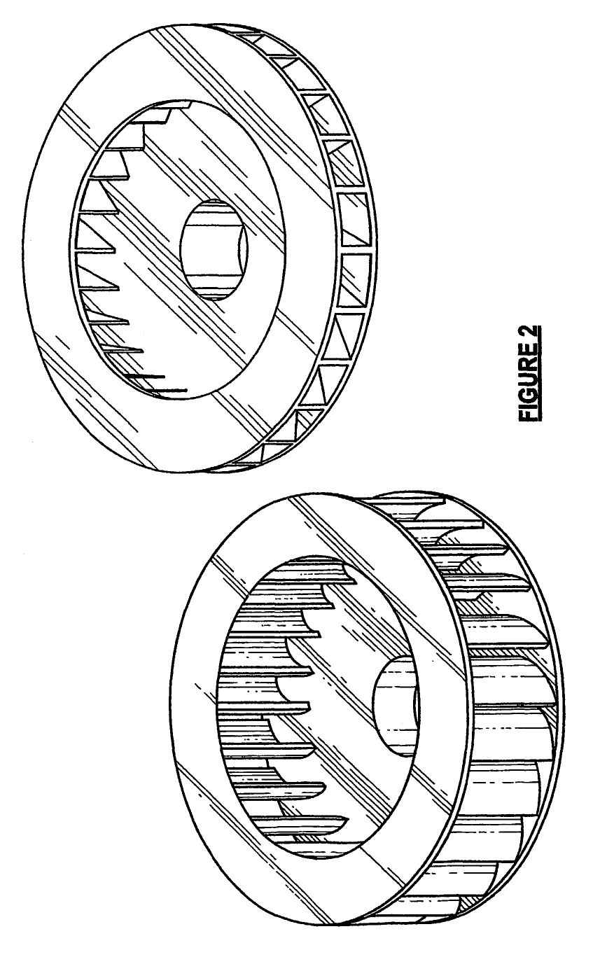

Rotor 3 shown in FIG. 2 is a small disc rotor with increased depth over the rotor Rotor 2. As can be seen the Rotor 3 has arcuate vanes. The radius of the vanes 4 is about the same radius as the overall rotor. A cord joining the two ends of each vane 4 is at approximately 25° to the radial direction. In the results discussed later the Rotor 3 is designated Rotor 3f when running in the forward swept direction and designated Rotor 3b when running in the back swept direction. The ratio of rotor diameter to vessel diameter for Rotor 3 is about 0.26. The ratio of rotor depth to rotor tip diameter is about 0.29. These rotors when run in the forward or reversed direction provide a high circulation. For each vessel a limit of rotor depth occurs when the rotor stalls because it cannot provide the pressure and flow requirement. Rotor 3f, which has four times the depth of Rotor 2 was found to stall in vessels with height to diameter ratios of 2.5 to 3. In the same vessels rotor Rotor 3b, i.e. operating in the backward swept direction, gave effective and stable operation.

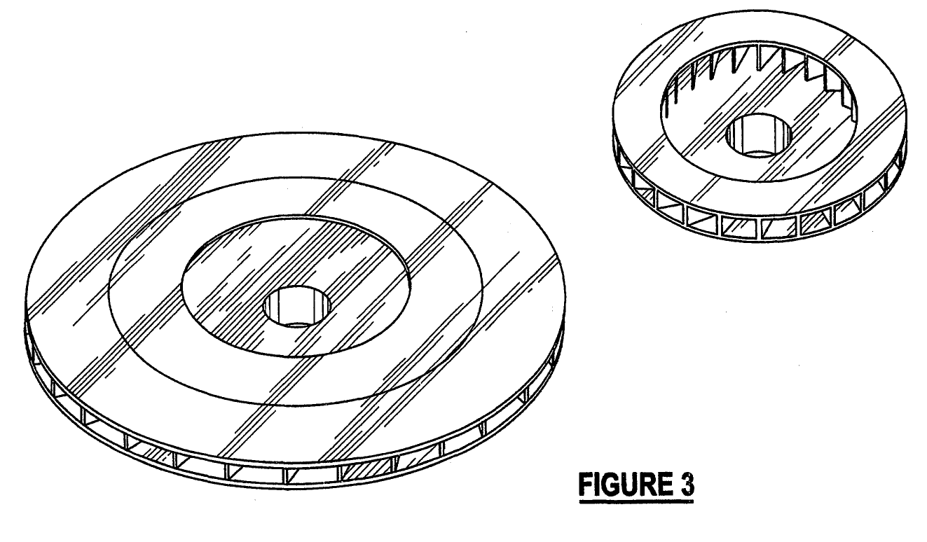

FIG. 3 shows a medium size rotor Rotor 4b. This rotor has a smaller diameter inlet obtained by fitting a further annular disc 5 in a rotor designated Rotor 4a with a large diameter inlet. The vanes 4 are straight and radially directed. Rotor 4b and Rotor 4a have a rotor diameter to vessel diameter of about 0.51. The ratio of rotor depth to rotor diameter is about 0.22.

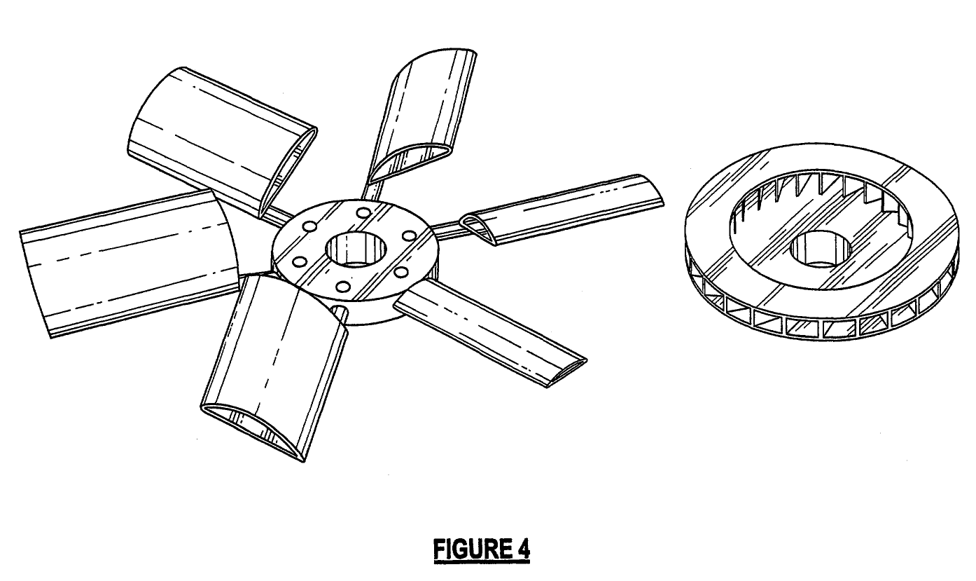

FIG. 4 shows a spoked rotor, Rotor 5. This rotor is formed by six hollow airfoil sections 6 supported by arms 7 about a central hub 8. The airfoil sections 6 are directed radially outwardly so the portion of the flow passes through a passage 9 within each spoke. The airfoil sections are set at an angle so that the external surfaces of the spokes produce thrust in the axial direction as well as a radially outward component. The flow through the hollow inside of the spokes provides a radially outward rotating flow similar to that provided by the disc type rotors described above. The Rotor 5 typically operates at a rotor diameter to vessel diameter ratio of about 0.65. In practise, about 20 to 30% of the flow induced by the rotor 31 that passes through the hollow passages in the spokes.

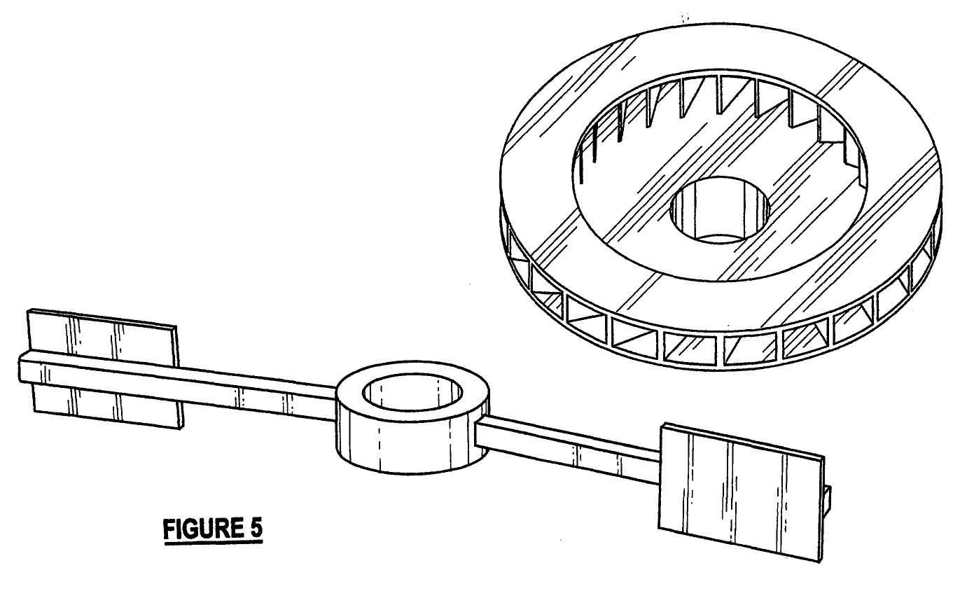

Rotor 6 shown in FIG. 5 has blades 10 supported from a hub 8 on outwardly extending arms 11. The blades are inclined to the direction of rotation of the rotor to induce a flow in the axial direction as well as the rotational flow in a radially outward direction. Rotor 6- typically operates with a rotor diameter to vessel diameter of about 0.6.

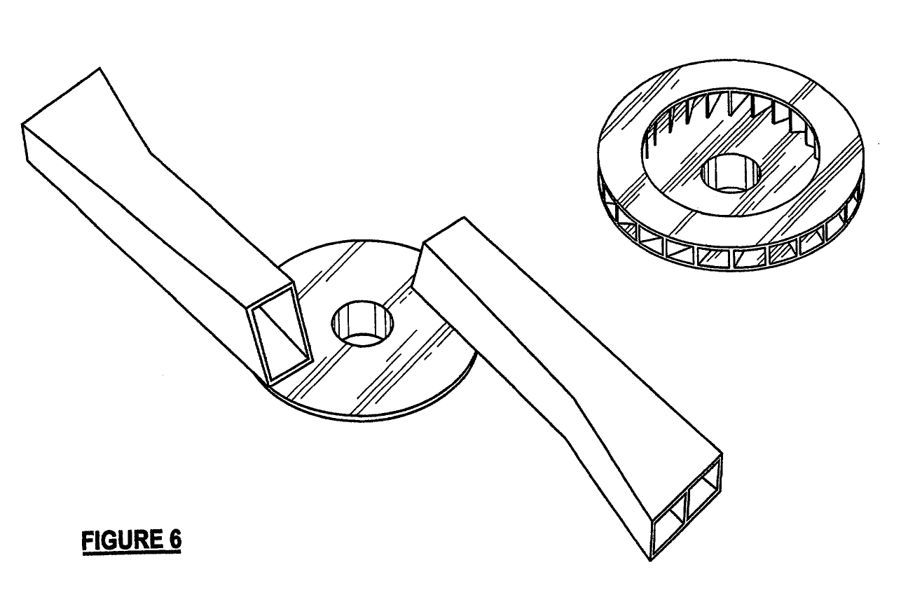

Rotor 7 shown in FIG. 6 is a large diameter two-spoked Rotor 7. Rotor 7 has a central hub 12 with two hollow spokes 13 of square section mounted to extend out to a tangent of a small circle about the axis of rotation. This ensures a smooth entry of the flow to the internal passage of the spokes. The spokes are flared at their outer end 14 and include an additional central vane 15 to direct the flow from the interior of the spoke 13. The flaring and central vane 15 direct the flow backwardly with respect to the direction of rotation. The ratio of tip diameter to vessel diameter for Rotor 7 is typically about 0.9.

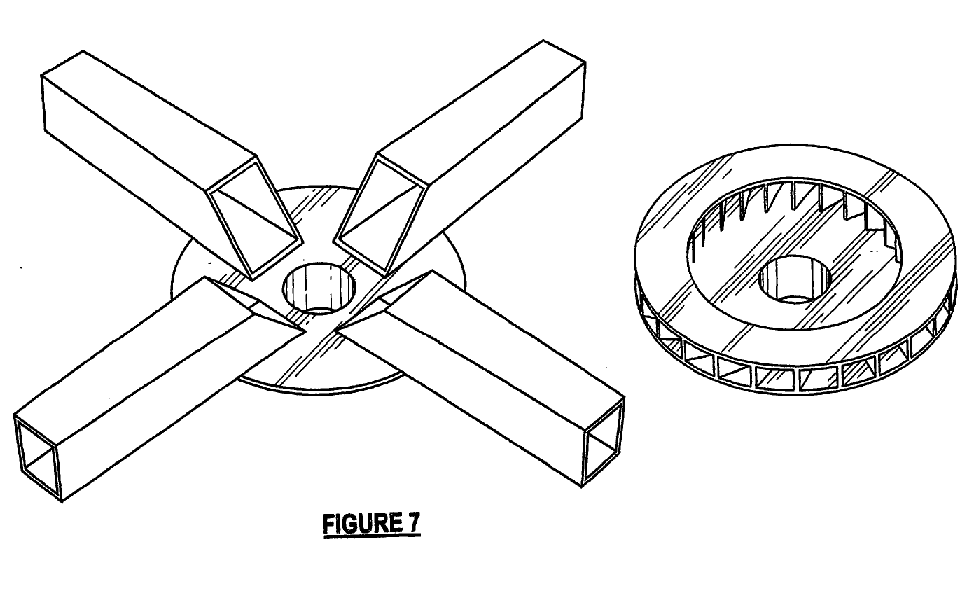

Rotor 8a shown in FIG. 7 is a four spoke, Rotor 8a. This rotor has four radially outwardly directed spokes 16 of square cross section. The results discussed later include the results for a rotor designated Rotor 8b which has the same configuration but uses only two diametrically opposed spokes 16. Rotor 8a (and Rotor 8b) typically have a ratio of rotor diameter to vessel diameter of about 0.65.

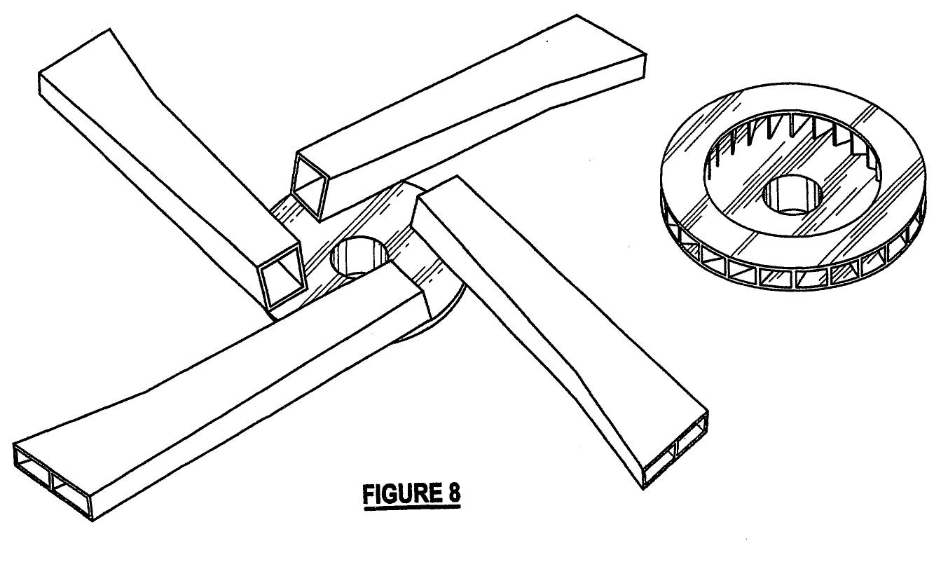

FIG. 8 shows a large diameter four spoke rotor, Rotor 9. This rotor is generally similar to the Rotor 7 described in relation to FIG. 6 above with the addition of two extra spokes 13. The ratio of rotor diameter to vessel diameter for Rotor 9 is about 0.9.

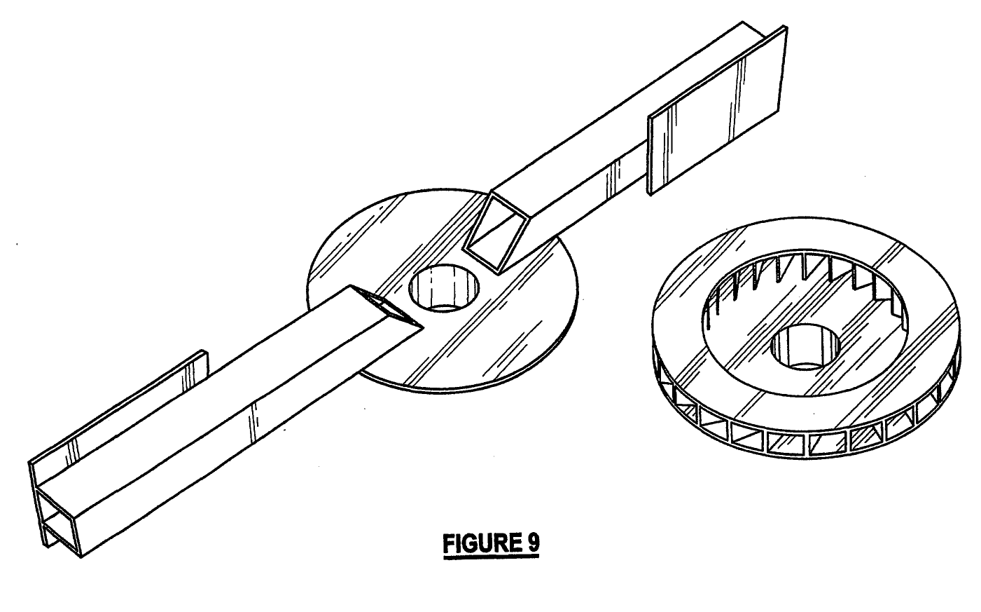

FIG. 9 shows a spoked rotor with attached plates, Rotor 10. This rotor has two radially extending hollow square section spokes 17 to which flat plates 18, 19 have been attached toward the end of each spoke 17 to increase the surface area presented to the flow. The additional flat plates 18, 19 result in a high torque rotor.

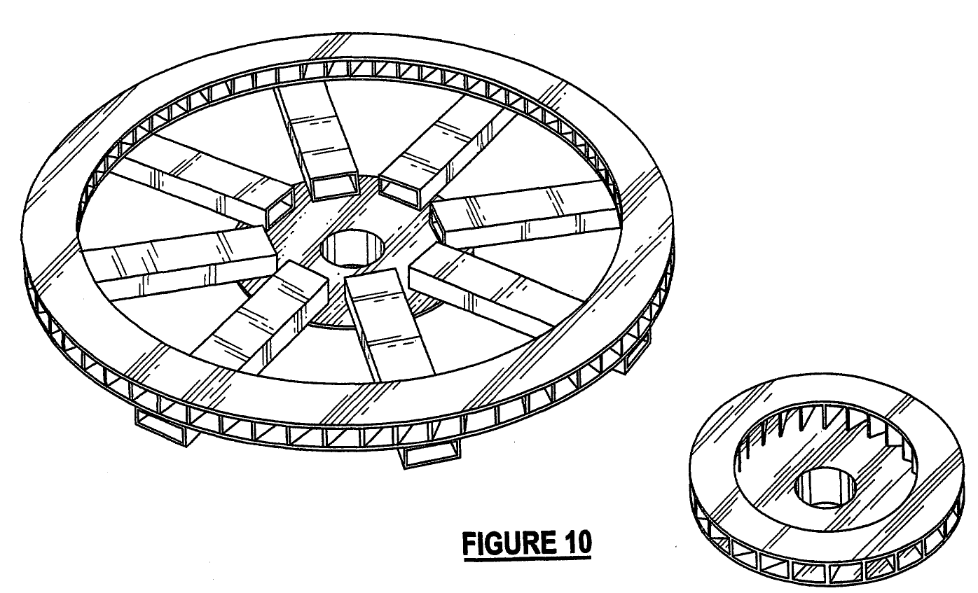

FIG. 10 shows a rotor incorporating a combination of the disc and spoke 20 features, Rotor 11. This rotor has eight radially extending rectangular hollow spokes 20 which support two annular discs 21, 22 separated by straight radially extending vanes 23.

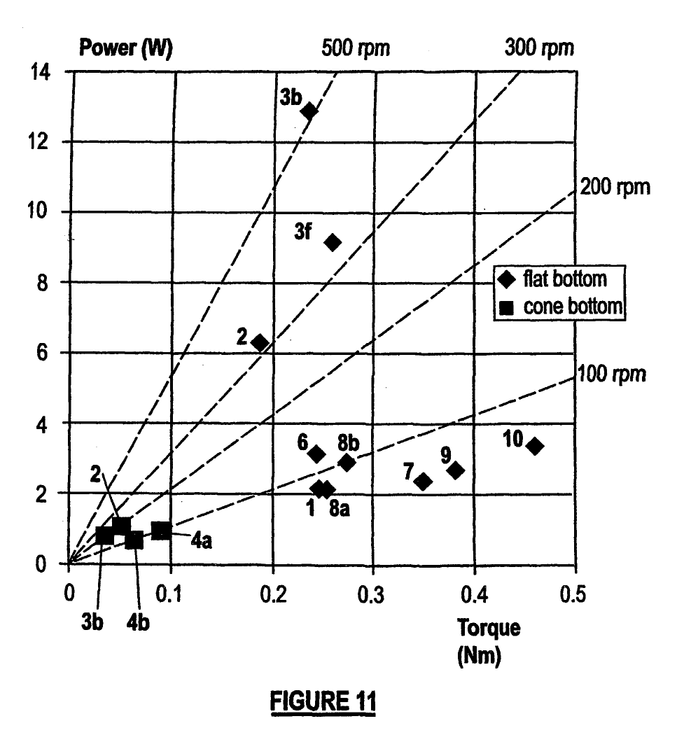

FIG. 11 provides a plot of the power and torque of various rotors at a condition of solids “just suspended” in both conical and flat bottomed vessels for the rotors described above. In general the minimum power to suspend is the determining parameter however high torque is desirable because it indicates high shear stress on the walls of the vessels which is needed to minimize scale. It is apparent from FIG. 11 that:

(i) the power required to suspend is clearly less in conical bottom vessels than in flat bottom vessels;

(ii) larger diameter rotors such as Rotor 7, Rotor 9 and Rotor 10 produce high torque at low speed;

(iii) larger diameter rotors tend to suspend solids at lower power;

(iv) rotors of spoke and disc designs, for example Rotor 1 and Rotor 8a can be produced with equal performance.

The foregoing describes only some embodiments of this invention and modifications can be made without departing from the scope of the invention.

1. A rotor to establish a swirling flow in liquid(s) contained in a vessel having an upper end, a lower end and a containing wall extending between the upper and lower ends by being submerged in the liquid adjacent the upper end, said rotor including two substantially parallel spaced apart generally planar discs extending perpendicular to an axis of rotation, an array of vanes interposed between the discs, one of said discs being annular to define an inlet to said array of vanes, said inlet controlling the size of an inner core region of said swirling flow.

2. A rotor as claimed in claim 1 wherein said vanes are evenly spaced around a circular region centred on the axis of rotation.

3. A rotor as claimed in claim 2 wherein said vanes are substantially perpendicular to the planes of the discs.

4. A rotor as claimed in claims 1 to 3 wherein the ratio of rotor diameter to vessel diameter is in the range of from 0.26 to 0.65.

5. A rotor as claimed in claims 1 to 4 wherein the ratio of the spacing between said discs to overall rotor diameter is in the range of 0.03 to 0.3.

6. A rotor to establish a swirling flow in liquid(s) contained in a vessel having an upper end, a lower end and a containing wall extending between the upper and lower ends by being submerged in the liquid adjacent the upper end, said rotor including at least two hollow spokes directed substantially radially outwardly from a central hub, said spokes each having a passage with an inlet directed toward said hub and a radially directed outlet such that rotation of the rotor produces a flow through the spokes that contributes to the rotational radially outward flow establishing said swirling flow.

7. A rotor as claimed in claim 6 wherein such spokes are directed radially outward.

8. A rotor as claimed in claim 6 wherein said spokes are directed outward at an angle to the radial direction.

9. A rotor as claimed in claims 6 to 8 including a plurality of said spokes evenly spaced about the central hub.

10. A rotor as claimed in claims 6 to 9 wherein said flow through said spokes about 30% of the required rotational radially outward flow.

11. A rotor as claimed in claims 6 to 10 wherein the outer surfaces of said spokes is shaped to direct the radially outward flow. More particularly, a lift or drag force can be applied by the surface of the rotors depending upon the selected shape and inclination of the shape relative to the fluid flow. In one preferred configuration airfoil sections can be used.

12. A rotor as claimed in claim 11 wherein at least some of said spokes have an airfoil section.

13. A rotor as claimed in claim 12 wherein said airfoil sections are preferably set at a pitch angles that determine the external surfaces of the spokes produce thrust in the axial direction as well as radially outward flow.

14. A rotor as claimed in claims 6 to 13 wherein the ratio of tip of spoke diameter to vessel diameter is between 0.5 and 0.9.

15. A rotor to establish a swirling flow in liquid(s) contained in a vessel having an upper end, a lower end and a containing wall extending between the upper and lower ends by being submerged in the liquid adjacent the upper end, said rotor including at least two blades directed radially outwardly from a central hub, said blades including at least one surface inclined to the direction of rotation of the rotor to induce a flow in the axial direction as the rotational radially outward flow towards the containing wall is created to establish said swirling flow.

16. A rotor as claimed in claim 15 wherein said blades extend from substantially adjacent the hub.

17. A rotor as claimed in claim 16 wherein said blades are mounted on outwardly extending arms.

18. A rotor as claimed in claims 15 to 17 wherein said blades have an airfoil section.

19. A rotor as claimed in claims 15 to 17 wherein said blades are hollow with an inlet directed toward the hub and a radially directed outlet.

20. An apparatus for mixing liquids including a rotor as claimed in any one of claims 1 to 19, a vessel having an upper end, a lower end and a containing wall extending between the upper and lower ends, said rotor being submerged in said liquid adjacent said upper end to induce a radially outward flow from said rotor to establish a swirling flow in the vessel.
